(19) United States
(12) Patent Application Publication
(10) Pub. No.: US 2003/0113532 A1
(43) Pub. Date: Jun. 19, 2003

(54) Kaolin pigment products

(76) Inventors: David O. Cummings, Warthen, GA (US); Anthony V. Lyons, Macon, GA (US)

Correspondence Address: Finnegan, Henderson, Farabow,, Garrett & Dunner, L.L.P., 1300 I Street, N.W., Washington, DC, 20005-3315, US

(21) Appl. No.: 10/082,232

(22) Filed: Feb. 26, 2002

Related U.S. Application Data
(60) Provisional application No. 60/272,253, filed on Feb. 28, 2001.
(60) Provisional application No. 60/279,148, filed on Mar. 27, 2001.

(51) Int. Cl. B32B 5/16

(52) U.S. Cl. 428/328; 428/331; 428/332

(57) ABSTRACT

A pigment product for use in a coating composition to provide a gloss coating on paper, the pigment product comprising a processed particulate kaolin having a particle size distribution such that at least about 80% by weight of the particles have an equivalent spherical diameter less than about 2 μm and in the range of from about 15% to about 40% by weight of the particles have an equivalent spherical diameter less than about 0.25 μm and the particles have a shape factor in the range of from about 30 to about 60 and wherein the pigment product comprises a blend of Component A: a particulate kaolin in which the particles have a shape factor of at least about 45, and Component B: a particulate kaolin in which the particles have a shape factor of less than about 20.

### PRIORITY CLAIM

This application claims the benefit of U.S. provisional application no. 60/272,253, filed Feb. 28, 2001, and U.S. provisional application no. 60/279,148, filed Mar. 27, 2001, both of which are incorporated herein by reference.

### FIELD OF THE INVENTION

The present invention relates to pigment products and their production and use in coating compositions. The present invention further relates to methods for making the pigment products and improved coated paper made using the pigment products.

The invention is concerned with the preparation of improved inorganic pigments for paper coating compositions, and, in particular, pigments for use in compositions for preparing gloss coated paper, especially lightweight and ultra lightweight coated paper.

### BACKGROUND OF THE INVENTION

Paper coating compositions are generally prepared by forming a fluid aqueous suspension of pigment material together with a hydrophilic adhesive and other optional ingredients. Lightweight coated, or LWC, paper is generally coated to a weight of from about 5 g.m⁻² to about 20 g.m⁻² on each side, and the total grammage, or weight per unit area of the coated paper is generally in the range of from about 49 g.m⁻² to about 70 g.m^{31 2}. The coating may conveniently be applied by means of a coating machine including a short dwell time coating head, which is a device in which a captive pond of coating composition under a slightly elevated pressure is held in contact with a moving paper web for a time in the range of from 0.0004 second to 0.01 second, before excess coating composition is removed by means of a trailing blade. However, other types of coating apparatus may also be used for preparing lightweight coated paper. LWC paper is generally used for printing magazines, catalogues and advertising or promotional material. The coated paper is required to meet certain standards of surface gloss and smoothness. For example, the paper is generally required to have a gloss value of at least about 32, and generally up to about 50, TAPPI units, and a Parker Print Surf value are generally in the range of from about 0.5 μm to about 1.6 μm.

Ultra lightweight coated, or ULWC, paper is sometimes otherwise known as light lightweight coated, or LLWC, paper and is used for catalogues and for advertising and promotional material sent through the mail to reduce mailing costs. The coating weight is generally in the range of from about 3 g.m⁻² to about 8 g.m⁻² per side. The total grammage is generally in the range of from about 30 g.m⁻² to about 48 g.m^{-2.}

An important white inorganic pigment for use in preparing coating compositions for the manufacture of LWC and ULWC papers is kaolin obtained from kaolin clay. Large deposits of kaolin clay exist in Devon and Cornwall, England and in the States of Georgia and South Carolina, United States of America. Important deposits also occur in Brazil, Australia, and in several other countries. Kaolin clay consists predominantly of the mineral kaolinite, together with small proportions of various impurities. Kaolinite exists in the form of hydrous aluminosilicate crystals in the shape of thin hexagonal plates, but these plates tend to adhere together face-to-face to form stacks. The individual plates may have mean diameters of 1 μm or less, but kaolinite particles in the form of stacks of plates may have an equivalent spherical diameter (esd) of up to 10 μm or more. Generally speaking, kaolin clay particles which have an equivalent spherical diameter of 2 μm or more are in the form of stacks of kaolinite plates, rather than individual plates.

As long ago as 1939, Maloney disclosed in U.S. Pat. No. 2,158,987 that the finish, or gloss, of a clay coated paper is greatly improved if the clay, before incorporation in the coating composition, is treated so that a large percentage, for example 80% by weight or more, of the clay particles have a size in the range of 0.1 μm to 2 μm. In order to increase the proportion of fine particles in the raw kaolin, the raw kaolin may, according to the disclosure in U.S. Pat. No. 2,158,987, be subjected, before a centrifuging step, to a grinding operation in which a suspension containing from about 50% to about 75% by dry weight of kaolin and a dispersing agent is subjected to pebble milling. When the kaolin from the finer fraction is recovered, mixed with a suitable paper coating binder, and applied to the surface of a base paper, a coating of good gloss and color is obtained.

Various pigment products which are made using the principles described by Maloney in U.S. Pat. No. 2,158,987 are commercially available and provide good gloss and smoothness in coated papers, especially for LWC and ULWC paper. For example, a prior art pigment product available from the Applicants and recommended for gloss coatings of LWC consists of a refined English kaolin product having a particle size distribution, “psd”, such that 89% by weight of the particles have an esd less than 2 μm, 74% by weight of the particles have an esd less than 1 μm and 25% by weight of the particles have an esd less than 0.25 μm.

We have now developed an improved pigment product. The present invention provides a pigment product showing improved gloss and brightness, particularly, but not exclusively, when used in a paper coating composition to coat paper to produce LWC, ULWC and other gloss paper products. Alternatively, the pigment product of the present invention may result in a reduction of the conventional amount of alternate pigments, for example, titanium dioxide, that would be have to be used.

### SUMMARY OF THE INVENTION

According to a first aspect of the present invention there is provided a pigment product for use in a coating composition to provide a gloss coating on paper, the pigment product comprising a processed particulate kaolin having a particle size distribution such that at least 80% by weight of the particles have an equivalent spherical diameter less than 2 μm and in the range of from about 15% to about 40% by weight of the particles have an equivalent spherical diameter less than 0.25 μm and the particles have a shape factor in the range of from about 30 to about 60 and where the pigment product comprises a blend of

Component A: a particulate kaolin in which the particles have a shape factor of at least about 45, and Component B: a particulate kaolin in which the particles have a shape factor of less than about 20.

Surprisingly and beneficially, the pigment product according to the first aspect of the invention provides improved gloss, brightness and opacity when incorporated in a coating composition, particularly for gloss paper coating applications. Alternatively, the pigment product according to the first aspect of the invention can retain the gloss, brightness, and opacity characteristic associated with prior products while naturally reducing the amounts of expensive alternate pigments, e.g., titanium dioxide, that must be used, i.e., the same grade of coated paper may be produced at reduced cost.

In this specification, the expression ‘paper’ embraces products which are of paper, board, card and the like.

The pigment product according to the first aspect of the invention has an unexpected combination of properties which are not normally obtained by conventional processing of kaolin clays from known sources.

A kaolin product of high shape factor is considered to be more “platey” than a kaolin product of low shape factor. “Shape factor” as used herein is a measure of an average value (on a weight average basis) of the ratio of mean particle diameter to particle thickness for a population of particles of varying size and shape as measured using the electrical conductivity method and apparatus described in GB-A-2240398/U.S. Pat. No. 5,128,606/EP-A-0528078, which are incorporated herein by reference in their entirety, and using the equations derived in these patent specifications. “Mean particle diameter” is defined as the diameter of a circle which has the same area as the largest face of the particle. In the measurement method described in EP-A-0528078 the electrical conductivity of a fully dispersed aqueous suspension of the particles under test is caused to flow through an elongated tube. Measurements of the electrical conductivity are taken between (a) a pair of electrodes separated from one another along the longitudinal axis of the tube, and (b) a pair of electrodes separated from one another across the transverse width of the tube, and using the difference between the two conductivity measurements, the shape factor of the particulate material under test is determined.

The kaolin deposits in England differ from those in the United States of America in that the English deposits are of primary kaolin, while those in the USA are of the sedimentary or secondary type. Kaolin was formed in geological times by the hydrothermal decomposition of the feldspar component of granite, and primary kaolin is that which is obtained directly from the granite matrix in which it was originally formed. On the other hand, secondary or (tertiary) kaolin also known as sedimentary kaolin has been washed out of the original granite matrix in geological times and has been deposited in an area remote from the site in which it was originally formed. Secondary kaolin deposits tend to have a higher proportion of fine particles, i.e., those having an esd smaller than about 2 μm, because the kaolin has undergone a certain amount of natural grinding during the course of its transport from its site of origin to its site of final deposition. See for example, Jepson (Jepson, W. B., “Kaolins: their properties and uses”, Phil Trans R Soc Lond, A311, 1984, pp 411-432).

Thus, the pigment product according to the present invention does not naturally occur from either the kaolins available from England or from Georgia, USA which together are representative of the different kaolins of the world.

The accompanying drawings, which are incorporated herein and constitute a part of the specification, illustrate embodiments of the invention, and, together with the description, serve to explain the principles of the invention

### BRIEF DESCRIPTION OF THE DRAWINGS

FIG. 1 graphically compares sheet brightness for different titanium dioxide level for inventive and prior art pigments.

FIG. 2 graphically compares opacity for different titanium dioxide levels for inventive and prior art pigments.

FIG. 3 graphically compares sheet gloss for different plastic pigment levels for inventive and prior art pigments.

### DETAILED DESCRIPTION OF THE INVENTION

The pigment product according to the first aspect of the present invention may be produced by treating and blending particulate hydrous kaolin minerals of the sedimentary type, more particularly raw or (partially) processed kaolin clays of the type which occurs in Georgia, USA.

The pigment product according to the first aspect of the invention may preferably have a particle size distribution, “psd”, such that in the range of from about 85% to about 95% by weight of the particles have an equivalent spherical diameter, esd, less than about 2 μm. In another embodiment, the range of from about 90% to about 93% by weight have an esd less than about 2 μm. According to one embodiment of the present invention, the range of from about 20% to about 30% by weight of the particles have an esd less than about 0.25 μm. In yet another embodiment, the range of from about 25% to about 30% by weight have an esd less than about 0.25 μm.

As will be appreciated by those skilled in the art, the psd of a particulate product such as the pigment product according to the present invention may be determined by measuring the sedimentation speeds of the dispersed particles of the particulate product under test through a standard dilute aqueous suspension using a SEDIGRAPH™ machine, e.g., SEDIGRAPH 5100, obtained from Micromeritics Corporation, USA. The size of a given particle is expressed in terms of the diameter of a sphere of equivalent diameter, which sediments through the suspension, i.e., an equivalent spherical diameter or esd, the parameter as referred to above. The SEDIGRAPH machine graphically records the percentage by weight of particles having esd less than a certain esd value versus esd.

According to the first aspect of the invention, the blended pigment product of the present invention comprises particles having a shape factor in the range of from about 30 to about 60. In another embodiment according to the present invention, the shape factor may be in the range of from about 35 to about 50. In still a third embodiment, the shape factor may be in the range of from about 35 to about 45. In a fourth embodiment, the shape factor is in the range of from about 40 to about 45.

According to a second aspect of the present invention there is provided a method of making a pigment product according to the first aspect of the invention, the method comprising providing Component A: a particulate kaolin in which the particles have a shape factor of at least about 45; providing Component B: a particulate kaolin in which the particles have a shape factor of less than about 20, and blending Component A with Component B.

In one embodiment of the present invention the blend (or weight) ratio of the Component A to the Component B may be from about 1:1 to about 100:1. In another embodiment, the blend ratio may be from about 2:1 to about 50:1. In yet a third embodiment, the blend ratio may be from about 2:1 to about 10:1.

According to the method of the second aspect of the invention, the Component A may be present in an amount of about 50% by weight, based on the dry weight of the blend, and the Component B may be present in an amount of about 50% by weight, based on the dry weight of the blend. In another embodiment of the method of the invention, the Component A may be present in an amount of about 85% by weight, based on the dry weight of the blend, and the Component B may be present in an amount of about 15% by weight, based on the dry weight of the blend. In yet another embodiment of the invention, the Component A may be present in an amount of about 70% by weight, based on the dry weight of the blend, and the Component B may be present in an amount of about 30% by weight, based on the dry weight of the blend.

Components A and B may be blended in aqueous form. The resulting blend may be processed by known means, such as, for example by an evaporation apparatus, to increase the solids content in the blend to a desired level. Alternatively, such dewatering of the product blend may be achieved by, for example, spray drying a portion of the blend and admixing the spray dried portion with a non-spray dried blend portion so as to increase the solids content of the blend to a desired level, such as in the range of from about 50% to about 80%. In another embodiment, the solids content of the blend is increased to the desired range, such as in the range of from about 60% to about 70%. Or, alternatively Components A and B may be prepared having a desired solids content (which may be in a form suitable for marketing) prior to blending such that advantageously the product blend may not require further processing.

Components A and B may be blended using known apparatus. The blend ratio of Component A to Component B may desirably be determined by the shape factor of Component A.

According to the method of the second aspect of the invention, Component A may be a processed kaolin and may preferably be produced by the method as described and claimed in Applicants patent specifications WO99/51815, WO00/59841, and WO00/59840, the disclosures of which are incorporated herein by reference in their entirety.

Component A may be produced by treating a raw particulate hydrous kaolin mineral of the sedimentary type, more particularly a raw or partially processed kaolin clay of the type which occurs in Georgia, USA.

Component A may have a particle size distribution “psd” such that at least about 80%, preferably at least about 84%, by weight of the particles have an esd smaller than about 2 μm and not less than about 12% by weight of the particles, preferably from about 15% to about 35%, especially about 18% to about 26%, have an esd smaller than about 0.25 μm. At least about 60%, preferably at least about 65% by weight have an esd less than about 1 μm. The mean particle esd may be from about 0.3 μm to about 0.8 μm, especially from about 0.5 μm to about 0.7 μm.

It is desired that Component A may be prepared by the method as described and claimed in WO99/51815, WO00/59841 and WO00/59840 in which the method comprises the steps of (a) mixing a raw or partially processed kaolin clay with water to form an aqueous suspension; (b) subjecting the suspension produced by step (a) to attrition grinding using a particulate grinding medium by a process in which the average shape factor of the kaolin clay is increased by at least 10, preferably at least 20; (c) separating the suspension of ground kaolin clay from the particulate grinding medium; and (d) dewatering the suspension of ground kaolin clay separated in step (c) to recover Component A therefrom.

In step (a) of the method for the manufacture of Component A, the kaolin clay may form from about 20% to about 70%, usually from about 20% to about 45% of the treated suspension. The raw kaolin clay may have a psd such that not more than about 40% by weight consists of particles having an esd larger than about 10 μm and not more than about 50% by weight, e.g., from about 20% to about 40% by weight, consists of particles having an esd smaller than about 2 μm.

The shape factor of the kaolin clay treated in step (a) may be less than about 15, e.g., in the range of from about 5 to about 10. Thus, the shape factor may be increased by a differential of at least about 30, in some cases at least about 40, e.g., from a shape factor value of less than about 15 to a shape factor value greater than about 55.

Component A may itself be prepared by blending a coarse kaolin clay with a fine kaolin clay as hereinafter described.

Thus, the kaolin clay employed in step (a) of the method of preparation of Component A may be a coarse component obtained from classifying, e.g., using a centrifuge, a standard blocky sedimentary kaolin clay, e.g., having a shape factor of from about 5 to about 10. The coarse component may have not more than about 50% by weight of particles having an esd less than about 2 μm and not more than about 10% by weight having an esd less than about 0.25 μm.

The psd of the kaolin clay may be adjusted so that it is in accordance with the Component A by blending from about 99 to about 50 parts by weight of the kaolin clay with from about 1 to about 50 parts by weight, especially from about 10 to about 30 parts by weight, of a fine platey kaolin component, i.e., having a shape factor of at least about 15, preferably from about 15 to about 40 and whose percentages by weight of particles smaller than about 2 μm and about 0.25 μm are respectively at least about 85% by weight and at least about 20% by weight. The fine platey kaolin component may be a kaolin derived from either a primary or a sedimentary deposit. The fine platey kaolin component may be added to the kaolin of or obtained from the coarse component prior to or after the grinding step (b).

The kaolin clay employed in step (a) may be subjected to one or more well known purification steps to remove undesirable impurities, e.g., between steps (a) and (b). For example, the aqueous suspension of kaolin clay may be subjected to a froth flotation treatment operation to remove titanium containing impurities in the froth. Alternatively, or in addition, the suspension may be passed through a high intensity magnetic separator to remove iron containing impurities.

Step (b) of the method of preparing Component A may comprise a process wherein the suspension of kaolin clay is treated by medium attrition grinding wherein an energy of from about 40 kWh to about 250 kWh per tonne of clay (on a dry weight basis) is dissipated in the suspension.

The process of step (b) may itself comprise a process comprising at least two stages, namely a first stage (b1) wherein delamination of the kaolin clay occurs and a second stage (b2) wherein comminution of the platelets of the kaolin clay occurs.

In step (c) of the method of preparation of Component A, the suspension of ground kaolin clay is conveniently separated from the particulate grinding medium in a known manner, e.g., by passing the suspension through a sieve of appropriate aperture size, for example. a sieve having nominal aperture sizes in the range of from about 0.1 mm to about 0.25 mm.

Following step (c) or step (d) the kaolin clay may be further treated to improve one or more of its properties. For example high energy liquid working, e.g., using a high speed mixer, may be applied to the product in slurry form, e.g., before step (d) or after step (d) and subsequent re-dispersion in an aqueous medium, e.g., during makedown of a coating composition.

In step (d) of the method of preparation of the Component A, the suspension of ground kaolin may be dewatered in one of the ways well known in the art, e.g., filtration, centrifugation, evaporation and the like.

According to the method of the second aspect of the invention, Component B may preferably be a processed kaolin and may preferably be produced by the method as described and claimed in Applicants patent specifications U.S. Pat. No. 5,085,707 and U.S. Pat. No. 5,168,083, the disclosures of which are incorporated herein by reference, in their entirety.

Thus, Component B may be prepared by the method comprising:

(a) dispersing a kaolin clay in an aqueous suspension of a water soluble dispersing agent to form an aqueous clay suspension,

(b) delaminating the kaolin clay in the aqueous clay suspension,

(c) defining the kaolin clay suspension into a coarse fraction and a fine fraction, discarding a first portion of the fine fraction and admixing a remaining portion of the fine fraction with the coarse fraction,

(d) surface treating the kaolin clay particles by admixing into the kaolin clay suspension a member from the group consisting of a water soluble amine, aluminum sulphate, and mixtures thereof,

(e) treating the kaolin clay suspension with a water soluble bleaching agent, and

(f) collecting the kaolin clay from the aqueous clay suspension as a filter cake.

Unusually, the pigment product according to the invention which comprises a kaolin consisting of particles having a shape factor of at least about 45 and a kaolin consisting of particles having a shape factor of less than about 20 provides enhanced gloss, brightness and opacity when such a pigment product is incorporated in a coating composition to make a gloss coated paper product. The blended pigment of the present invention having a component with a shape factor of less than about 20 would be expected to have properties inferior to those of the individual component having a shape factor of at least about 45. The blended pigment of the present invention provides improved properties.

Furthermore, the pigment product according to the invention comprising particles having a shape factor in the range of from about 30 to about 60 and which provides improved properties as just hereinbefore described is especially surprising when compared to other prior art pigments having a similar shape factor. It is believed that by blending kaolins as provided by the invention having a desired particle shape factor (particle shape) and a desired particle size distribution may provide advantageous synergistic properties which are expressed by improved light scattering ability and improved coverage of a paper product coated with a coating composition incorporating the pigment product of the invention.

Furthermore and beneficially, use of the pigment product provided by the invention in a paper coating composition may advantageously result in a reduction of the conventional amount of titanium dioxide pigment and plastic pigment (hollow core and solid core) which would typically be used in a paper coating composition, such as up to about 4 parts by weight of each pigment based on the weight of the pigment product. Titanium dioxide and plastic pigment are relatively expensive pigments and the latter pigment may cause undesirable viscosity problems in coating compositions.

The pigment product according to the first aspect of the present invention may be used in paper coating as follows.

According to the present invention in a third aspect there is provided a coating composition for use in producing gloss coatings on paper and other substrates which composition comprises an aqueous suspension of a particulate pigment and a hydrophilic adhesive or binder, wherein the particulate pigment comprises the pigment product according to the first aspect of the invention.

The solids content of the paper coating composition according to the third aspect of the invention may be greater than about 60% by weight, preferably at least 70%, preferably as high as possible maintaining suitable fluidity to be used in coating. The composition may include a dispersing agent, e.g., up to about 2% by weight of a polyelectrolyte based on the dry weight of pigment present. For example, polyacrylates and copolymers containing polyacrylate units are well known as suitable polyelectrolytes. The pigment product according to the first aspect of the invention may be used as the sole pigment in the paper coating composition according to the third aspect, or it may be used in conjunction with one or more other known pigments, such as for example, (commercially available) kaolin, calcined kaolin, natural or precipitated calcium carbonate, titanium dioxide, calcium sulphate, satin white, talc and so called ‘plastic pigment’. When a mixture of pigments is used the pigment product according to the first aspect of the invention is preferably present in the mixture in an amount of at least 80% of the total dry weight of the mixed pigments.

The binder of the composition according to the third aspect may comprise an adhesive derived from natural starch obtained from a known plant source, for example, wheat, maize, potato or tapioca although it is not essential to use starch as a binder ingredient. Other binders, which may be used with or without starch are mentioned later.

Where starch is employed as a binder ingredient, the starch may be unmodified or raw starch, or it may be modified by one or more chemical treatments known in the art. The starch may, for example, be oxidized to convert some of its —CH₂OH groups to —COOH groups. In some cases the starch may have a small proportion of acetyl-COCH₃, groups. Alternatively, the starch may be chemically treated to render it cationic or amphoteric, i.e., with both cationic and anionic charges. The starch may also be converted to a starch ether, or hydroxyalkylated starch by replacing some —OH groups with, for example, —O—CH₂—CH₂OH groups, —O—CH₂—CH₃ groups or —O—CH₂—CH₂—CH₂OH groups. A further class of chemically treated starches which may be used are those known as the starch phosphates. Alternatively, the raw starch may be hydrolyzed by means of a dilute acid or an enzyme to produce a gum of the dextrin type. The amount of the starch binder used in the composition according to the third aspect is preferably from about 2% to about 25% by weight, based on the dry weight of pigment. The starch binder may be used in conjunction with one or more other binders, for example synthetic binders of the latex or polyvinyl acetate or polyvinyl alcohol type. When the starch binder is used in conjunction with another binder, e.g., a synthetic binder, the amount of the starch binder is preferably from about 2% to about 20% by weight, and the amount of the synthetic binder from about 2% to about 12% by weight, both based on the weight of dry pigment. Preferably, at least about 50% by weight of the binder mixture comprises modified or unmodified starch.

According to the present invention in a fourth aspect there is provided a method of use of the coating composition according to the third aspect which comprises applying the composition to coat a sheet of paper and calendering the paper to form a gloss coating thereon. Preferably, the gloss coating is formed on both sides of the paper.

Calendering is a well known process in which paper smoothness and gloss is improved and bulk is reduced by passing a coated paper sheet between calender nips or rollers one or more times. Usually, elastomer coated rolls are employed to give pressing of high solids compositions. An elevated temperature may be applied. Five or more passes through the nips may be applied.

The paper after coating and calendering in the method according to the fourth aspect may have a total weight per unit area in the range about 30 g.m⁻² to about 70 g.m⁻². In another embodiment the total weight per unit is in the range about 49 g.m⁻² to about 65 g.m⁻² or about 35 g.m⁻² to about 48 g.m⁻². The final coating may have a weight per unit area preferably from about 3 g.m⁻² to about 20 g.m⁻². In yet another embodiment the final coating weight is from about 5 g.m⁻² to about 13 g.m⁻² for LWC and about 4 g.m⁻² to about 8 g.m⁻² for ULWC. Such a coating may be applied to both sides of the paper. Thus, the coated paper may be LWC or ULWC paper. The paper gloss may be greater than about 45 TAPPI units and the Parker Print Surf value at a pressure of 1 MPa of each paper coating may be less than about 1 μm.

The gloss of a coated paper surface may be measured by means of a test laid down in TAPPI Standard No 480 ts-65. The intensity of light reflected at an angle from the surface of the paper is measured and compared with a standard of known gloss value. The beams of incident and reflected light are both at an angle of 75° to the normal to the paper surface. The results are expressed in TAPPI gloss units. The gloss of the pigment product according to the first aspect may be greater than about 50, in some cases greater than about 55, TAPPI units.

The Parker Print Surf test provides a measure of the smoothness of a paper surface, and comprises measuring the rate at which air under pressure leaks from a sample of the coated paper which is clamped, under a known standard force, between an upper plate which incorporates an outlet for the compressed air and a lower plate, the upper surface of which is covered with a sheet of either a soft or a hard reference supporting material according to the nature of the paper under test. From the rate of escape of the air, a root mean cube gap in μm between the paper surface and the reference material is calculated. A smaller value of this gap represents a higher degree of smoothness of the surface of the paper under test.

An improvement is provided by the present invention where the binder present in the coating composition according to the third aspect comprises starch. However, an improvement is also obtained where other known starch-free binders are employed (with or without starch present). In each case the adhesive or binder may form from about 4% to about 30% by weight of the solids content of the composition. In another embodiment, the adhesive or binder may be from about 8% to about 20% by weight of the solids content of the composition. In yet another embodiment, the adhesive or binder may be from about 8% to about 15% by weight of the solids content of the composition. The amount employed will depend upon the composition and the type of adhesive, which may itself incorporate one or more ingredients. For example, hydrophilic adhesives used in the art, e.g., incorporating one or more of the following adhesive or binder ingredients may be used in the following stated amounts:

(a) latex: levels range from about 4% by weight to about 20% by weight. The latex may comprise, for example, a styrene butadiene, acrylic latex, vinyl acetate latex, or styrene acrylic copolymers.

(b) other binders: levels range from, for example about 4% by weight to about 20% by weight. Examples of other binders include casein, polyvinyl alcohol and polyvinyl acetate.

Additives in various known classes may, depending upon the type of coating and the material to be coated, be included in the coating composition according to the third aspect of the present invention. Examples of such classes of optional additive are as follows:

(a) cross linkers: e.g., in levels of up to about 5% by weight; for example glyoxals, melamine formaldehyde resins, ammonium zirconium carbonates.

(b) water retention aids: e.g., in up to about 2% by weight, for example, sodium carboxymethyl cellulose, hydroxyethyl cellulose, PVA (polyvinyl acetate), starches, proteins, polyacrylates, gums, alginates, polyacrylamide bentonite and other commercially available products sold for such applications.

(c) viscosity modifiers or thickeners: e.g., in levels up to about 2% by weight; for example, polyacrylates, emulsion copolymers, dicyanamide, triols, polyoxyethylene ether, urea, sulphated castor oil, polyvinyl pyrrolidone, montmorillonite, CMC (carboxymethyl celluloses), sodium alginate, xanthan gum, sodium silicate, acrylic acid copolymers, HMC (hydroxymethyl celluloses), HEC (hydroxyethyl celluloses) and others.

(d) lubricity/calendering aids: e.g., in levels up to about 2% by weight, for example, calcium stearate, ammonium stearate, zinc stearate, wax emulsions, waxes, alkyl ketene dimer, glycols.

(e) dispersants: e.g., in levels up to about 2% by weight, for example, polyelectrolytes such as polyacrylates and copolymers containing polyacrylate species, more particularly, polyacrylate salts (e.g., sodium and aluminium optionally with a group II metal salt), sodium hexametaphosphates, non-ionic polyol, polyphosphoric acid, condensed sodium phosphate, non-ionic surfactants, alkanolamine and other reagents commonly used for this function.

(f) antifoamers/defoamers: e.g., in levels up to about 1% by weight, for example, blends of surfactants, tributyl phosphate, fatty polyoxyethylene esters plus fatty alcohols, fatty acid soaps, silicone emulsions and other silicone containing compositions, waxes and inorganic particulates in mineral oil, blends of emulsified hydrocarbons and other compounds sold commercially to carry out this function.

(g) dry or wet pick improvement additives: e.g., in levels up to about 2% by weight, for example, melamine resin, polyethylene emulsions, urea formaldehyde, melamine formaldehyde, polyamide, calcium stearate, styrene maleic anhydride and others.

(h) dry or wet rub improvement and abrasion resistance additives: e.g., in levels up to about 2% by weight, for example, glyoxal based resins, oxidized polyethylenes, melamine resins, urea formaldehyde, melamine formaldehyde, polyethylene wax, calcium stearate and others.

(i) gloss-ink hold-out additives: e.g., in levels up to about 2% by weight, for example, oxidized polyethylenes, polyethylene emulsions, waxes, casein, guar gum, CMC, HMC, calcium stearate, ammonium stearate, sodium alginate and others.

(j) optical brightening agents (OBA) and fluorescent whitening agents (FWA): e.g., in levels up to about 1% by weight, for example stilbene derivatives.

(k) dyes: e.g., in levels up to about 0.5% by weight.

(I) biocides/spoilage control agents: e.g. in levels up to 1% by weight, for example, metaborate, sodium dodecylbenene sulphonate, thiocyanate, organosulphur, sodium benzonate and other compounds sold commercially for this function.

(m) levelling and evening aids: e.g., in levels up to about 2% by weight, for example, non-ionic polyol, polyethylene emulsions, fatty acid, esters and alcohol derivatives, alcohol/ethylene oxide, sodium CMC, HEC, alginates, calcium stearate and other compounds sold commercially for this function.

(n) grease and oil resistance additives: e.g., in levels up to about 2% by weight, e.g., oxidized polyethylenes, latex, SMA (styrene maleic anhydride), polyamide, waxes, alginate, protein, CMC, HMC.

(o) water resistance additives: e.g., in levels up to about 2% by weight, e.g., oxidized polyethylenes, ketone resin, anionic latex, polyurethane, SMA, glyoxal, melamine resin, urea formaldehyde, melamine formaldehyde, polyamide, glyoxals, stearates and other materials commercially available for this function.

(p) insolubilizer: e.g., in levels up to about 2% by weight.

For all of the above additives, the percentages by weight quoted are based on the dry weight of pigment (100%) present in the composition. Where the additive is present in a minimum amount the minimum amount may be 0.01% by weight based on the dry weight of pigment.

The method according to the fourth aspect of the present invention may be carried out in a known way which will depend upon the material to be coated, the coating composition to be applied and other factors as determined by the operator, e.g., speed and ease of runnability e.g., using a conventional coating machine.

Methods of coating paper and other sheet materials are widely published and well known. For example, there is a review of such methods published in Pulp and Paper International, May 1994, page 18 et seq. Sheets may be coated on the sheet forming machine, i.e., “on-machine”, or “off-machine” on a coater or coating machine. Use of high solids compositions is desirable in the coating method because it leaves less water to evaporate subsequently. However, as is well known in the art, the solids level should not be so high that high viscosity and levelling problems are introduced.

All known methods of coating for use in the method according to the fourth aspect of the present invention require (i) a means of applying the coating composition to the material to be coated, viz., an applicator; and (ii) a means for ensuring that a correct level of coating composition is applied, viz., a metering device. When an excess of coating composition is applied to the applicator, the metering device is downstream of it. Alternatively, the correct amount of coating composition may be applied to the applicator by the metering device, e.g., as a film press. At the points of coating application and metering, the paper web support ranges from a backing roll, e.g., via one or two applicators, to nothing i.e., just tension. The time the coating is in contact with the paper before the excess is finally removed is the dwell time—and this may be short, long or variable.

The coating is usually added by a coating head at a coating station. According to the quality desired, paper grades are uncoated, single coated, double coated and even triple coated. When providing more than one coat, the initial coat (precoat) may have a cheaper formulation and optionally less pigment in the coating composition. A coater that is applying a double coating, i.e., a coating on each side of the paper, will have two or four coating heads, depending on the number of sides coated by each head. Most coating heads coat only one side at a time, but some roll coaters (e.g., film press, gate roll, size press) coat both sides in one pass.

Examples of known coaters which may be employed include air knife coaters, blade coaters, rod coaters, bar coaters, multi-head coaters, roll coaters, roll/blade coaters, cast coaters, laboratory coaters, gravure coaters, kiss coaters, liquid application systems, reverse roll coaters and extrusion coaters.

In all examples of coating compositions described in this specification, water is added to the solids to give a concentration of solids which when coated onto a sheet to a desired target coat weight has a rheology suitable for the composition to be coated with a pressure (e.g., a blade pressure) of between about 1 and about 1.5 bar. Generally, the solids content may be from about 60% to about 70% by weight.

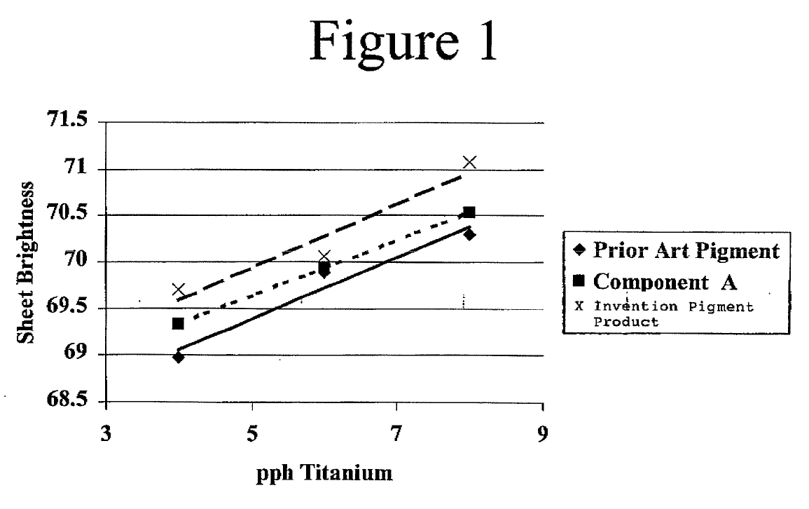

FIG. 1 is a graph of Sheet Brightness versus Titanium dioxide level (ppH) which compares the sheet brightness of the invention pigment product (Sample C), component A, and a prior art pigment, i.e. pigment 2 (having a shape factor of 44.6) for a given Titanium dioxide level.

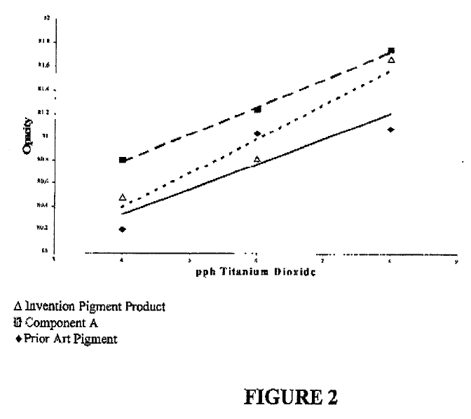

FIG. 2 is a graph of Opacity versus Titanium dioxide level (ppH) which compares the opacity of the invention pigment product (Sample C), component A, and a prior art pigment, i.e. pigment 2 (having a shape factor of 44.6) for a given Titanium dioxide level.

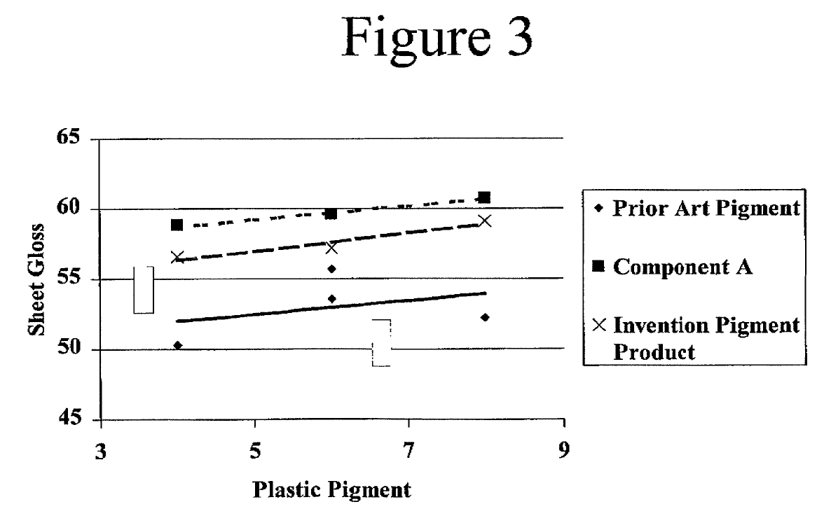

FIG. 3 is a graph of Sheet Gloss versus Plastic pigment level which compares the sheet gloss of the invention pigment product (Sample C), component A, and a prior art pigment, i.e. pigment 2 (having a shape factor of 44.6) for a given Plastic pigment level.

Embodiments of the present invention will now be described by way of example only with reference to the accompanying drawings and the following illustrative Examples.

### EXAMPLE 1

### Preparation of Component A

A raw kaolin clay from a sedimentary deposit in Georgia, USA was suspended in water and the resultant suspension was passed through a high intensity magnetic separator to remove iron-containing impurities therefrom. After the magnetic separation step the kaolin clay was found to have a psd such that 30% by weight consisted of particles having an esd smaller than 2 μm, and 7.0% by weight consisted of particles having an esd smaller than 0.25 μm. The shape factor of the kaolin clay as measured by the method described in GB-A-2240398 was found to be 6.8.

The suspension of kaolin clay was then subjected to relatively gentle attrition grinding in a grinding chamber provided with a submerged internal impeller, the speed of rotation of which was insufficient to form a vortex in the suspension contained in the grinding chamber. The grinding medium was a silica sand having grains in the size range from about 0.6 mm to about 0.85 mm. The grinding was continued for a time such that the amount of energy dissipated in the suspension was 50.7 kWh per tonne of kaolin clay (on a dry weight basis). At the completion of this grinding step, the kaolin clay was found to have a psd such that 71.2% by weight consisted of particles having an esd smaller than 2 μm and 5.0% by weight consisted of particles having an esd smaller than 0.25 μm. The mean particle shape factor as measured by the method described in GB-A-2240398 was found to be 52.

The suspension of ground kaolin clay was separated from the grinding medium by elutriation and was then subjected to a second stage of attrition grinding in a grinding chamber equipped with a high-speed impeller which was capable of generating a vortex in the suspension contained in the chamber. The grinding medium used was Ottawa sand, a relatively pure silica sand with rounded grains, having a distribution of grain sizes between 0.5 and 1.0 mm. The solids concentration of the suspension was 27% by weight based on the dry weight of the kaolin clay. The grinding chamber was operated continuously in closed cycle with a hydrocyclone which separated sufficiently ground particles as product and returned insufficiently ground particles to the grinding chamber. The suspension of ground kaolin clay was discharged continuously through apertures high in the side walls of the grinding chamber, these apertures being covered with sieves of nominal aperture 0.25 mm to hold back the grains of the grinding medium. The suspension of ground kaolin clay passing through the sieves was collected in a trough surrounding the grinding chamber, from whence it was pumped under pressure to the hydrocyclone.

Sample A of the suspension of the ground kaolin clay was withdrawn from the recirculating system after a time sufficient to dissipate in the suspension 60 kWh of energy per tonne of kaolin clay (on a dry weight basis). The percentages by weight of particles in Sample A having esds larger than 10 μm, smaller than 2 μm, smaller than 1 μm and smaller than 0.25 μm, and the mean particle shape factor of Sample A (which is Component A) was measured. The results are set forth in Table 1 as follows.

TABLE 1

| | | | | | | Mean |
|---|---|---|---|---|---|---|
| | Energy | % by weight of particles | | | | particle |
| Sample | dissipated | Larger | Smaller | Smaller | Smaller | shape |
| (Component A) | (kWh ·tonne⁻¹) | than 10 μm | than 2 μm | than 1 μm | than 0.25 μm | factor |
| A | 60 | 0.2 | 89.9 | 72.6 | 17.9 | 60.0 |

### EXAMPLE 2

### Preparation of Component B

A kaolin clay was blunged in water with sodium hexametaphosphate to form an aqueous kaolin suspension. This suspension was then subjected to delamination in a wet grinder. The delaminated suspension was then subjected to defining to a defining level of 40.5% by centrifuging in a disc-nozzle centrifuge equipped with internal recycle. The delaminated and defined kaolin recovered from the centrifuge had a particle size distribution of 91% by weight less than 2.0 μm and 8% by weight less than 0.3 μm, i.e., colloidal particles. Thus, the particle size distribution was narrowed such that 83% by weight of the kaolin particles therein lay between 0.3 μm and 2 μm. The defined and delaminated kaolin suspension was then treated with aluminum sulphate in aqueous suspension at a treatment level of 0.7% by weight of dry clay and with hexamethylenediamine in aqueous suspension at a treatment level of 0.08% by weight of dry clay. The kaolin clay suspension was then treated with a bleaching agent, filtered, rinsed and redispersed to form Sample B (Component B).

The physical properties of Sample B were measured and the results are set forth in Table 2 as follows.

TABLE 2

| | Sample B |
|---|---|
| | (Component B) |
| <2 μm | 93.5 |
| <1 μm | 77.5 |
| <0.5 μm | 53.1 |
| <0.25 μm | 21.8 |
| <0.2 μm | 15.2 |
| Brookfield | 65.2 |
| Viscosity | |
| (% Solids) | |
| cps @ 20 rpm | 420 |
| Shape Factor | 14.7 |

### EXAMPLE 3

### Preparation of Invention Pigment Product

Ground kaolin Sample A (representing Component A) produced in Example 1, and, defined and delaminated kaolin Sample B (representing Component B) were blended together in a known mixing vessel to produce the pigment product (Sample C) embodying the invention. The kaolin product blend consisted of 70% by weight of the Sample A, based on the weight of the blend suspension, and 30% by weight of the Sample B, based on the weight of the blend suspension. The kaolin product (Sample C) was processed through an evaporator to raise the solids content to about 64% by weight. The kaolin product (Sample C) had a psd such that 90.8% by weight of the particles had an esd less than 2 μm and 20.4% by weight of the particles had an esd less than 0.2 μm. The shape factor of the product was found to be 43.6.

### EXAMPLE 4

The kaolin product Sample C produced in Example 3 above was used as a pigment in a coating composition used for preparing an ULWC for offset printing. The coating composition had the composition shown in Table 3 as follows.

TABLE 3

| Ingredient | Parts by weight |
|---|---|
| Pigment under test | 85 |
| Calcined kaolin | 5 |
| Titanium dioxide | 5 |
| Hollow Core Plastic Pigment | 5 |
| Starch binder | 8 |
| Synthetic latex binder | 8 |

The calcined kaolin had a particle size distribution such that 90% by weight consisted of particles having an esd smaller than 2 μm.

The starch binder was a hydroxyethyl ether of corn starch which is marketed under the trade name “PENFORD GUM 290”.

The synthetic latex binder was a styrene butadiene rubber binder of the type which has been found to be suitable for use in offset coating formulations. The parts by weight shown are parts by weight of latex solids.

The kaolin product C in accordance with an embodiment of the invention was compared with two commercially available products, namely commercially available pigments 1 and 2, which were each separately made into the composition shown in Table 3 above.

Commercially available pigment 1 was a kaolin equivalent to Component A having a particle size distribution such that 90.4% by weight consisted of particles having an esd smaller than 2 μm, 75.5% by weight consisted of particles having an esd smaller than 1.0 μm and 23.3% consisted of particles having an esd smaller than 0.2 μm. The shape factor of the product was 60.2.

Commercially available pigment 2 was a kaolin clay having a psd such that 82.9% by weight consisted of particles having an esd smaller than 2 μm, 68.3% by weight consisted of particles having an esd smaller than 1 μm and 21.3% by weight consisted of particles having an esd smaller than 0.2 μm. The particle shape factor of the product was 44.6.

Each composition under test was coated onto base paper of substance weight 30 g.m⁻² by means of a coating machine of the type described in GB-A-1032536 fitted with a short dwell time head. The paper speed was 1100 m.min⁻¹. Samples of a coated paper were prepared at different coat weights in the range of from about 4 g.m⁻² to about 7g.m⁻². The coated paper was dried and then subjected to calendering (finishing) by passage ten times between the rolls of a supercalender at a temperature of 100° C. and a pressure of 7 MPa.

The samples of calendered coated paper prepared from each of the three coating compositions were then tested for gloss according to TAPPI Standard No 480 ts-65, brightness, or percentage reflectance to light of a 457 nm wavelength, opacity, print gloss, and Parker Print Surf using the soft backing material and a pressure of 1000 kPa. In each case the measured values were plotted graphically against coat weight, and the value which corresponded to a coat weight of 4.5 g.m⁻² was found by interpolation.

The results are set forth in Tables 4 and 5 as follows.

TABLE 4
(At Equivalent Finishing Conditions)

| | | % reflectance | Parker | | | | |
|---|---|---|---|---|---|---|---|
| | Gloss | to light of | Print | Opacity | | | |
| | (TAPPI | 457 nm | Surf | (TAPPI | Print | Delta | Dry |
| Pigment | units) | wavelength | 1000 kPa | units) | Gloss | Gloss | Pick |
| Pigment in | 48.6 | 69.7 | 1.18 | 80.3 | 66.2 | 17.6 | 43.0 |
| accordance | | | | | | | |
| with an em- | | | | | | | |
| bodiment of | | | | | | | |
| the invention | | | | | | | |
| Commercially | 47.5 | 69.1 | 1.18 | 80.2 | 65.5 | 18.0 | 48.2 |
| available | | | | | | | |
| pigment 1 | | | | | | | |
| Commercially | 42.9 | 68.7 | 1.30 | 79.9 | 62.1 | 19.2 | 47.9 |
| available | | | | | | | |
| pigment 2 | | | | | | | |

TABLE 5
(At Equivalent Sheet Gloss)

| | Gloss | % reflectance to | Parker | Opacity | | |
|---|---|---|---|---|---|---|
| | (TAPPI | light of 457 nm | Print Surf | (TAPPI | Print | Delta |
| Pigment | units) | wavelength | 1000 kPa | units) | Gloss | Gloss |
| Pigment in | 48.6 | 69.7 | 1.18 | 80.3 | 66.2 | 17.6 |
| accordance with an | | | | | | |
| embodiment of the | | | | | | |
| invention | | | | | | |
| Commercially | 47.5 | 69.1 | 1.18 | 80.2 | 65.5 | 18.0 |
| available pigment 1 | | | | | | |
| Commercially | 48.0 | 68.0 | 1.20 | 79.1 | 64.8 | 16.7 |
| available pigment 2 | | | | | | |

It can be seen from Tables 4 and 5 that the pigment in accordance with an embodiment of the invention provides an ULWC paper, suitable for use in offset printing, which paper has improved gloss, brightness, opacity and print gloss as compared with coated papers which have been prepared using commercially available pigments which are generally recommended for preparing coated papers of this type. The results for the invention pigment are particularly improved over the commercially available pigment 2 which is especially surprising because the invention pigment and pigment 2 have a very similar shape factor.

Further paper coating compositions were prepared as described in this Example wherein the respective levels of titanium dioxide and plastic pigment (hollow core) were varied from about 4 to about 8 parts, in 2 part increments. Samples of coated paper were prepared and the various properties measured as described in this Example. The results are illustrated in FIGS. 1, 2 and 3. As shown in FIG. 1, the invention pigment product exhibits a higher sheet brightness in an ULWC paper compared to component A and the prior art pigment, i.e., pigment 2, at a given titanium dioxide level. A coated paper prepared using the invention pigment product may have an equivalent sheet brightness as a coated paper prepared using the prior art pigment which is especially beneficial as up to about 2 parts of the titanium dioxide have been replaced.

As shown in FIG. 2, the invention pigment product exhibits a higher opacity in an ULWC paper compared to the prior art pigment. Advantageously, the coated paper prepared using the invention pigment product may comprise up to less than 1 part of titanium dioxide compared to a coated paper prepared using the prior art pigment.

As shown in FIG. 3, the invention pigment product exhibits a higher sheet gloss in an ULWC paper compared to the prior art pigment.

### EXAMPLE 5

The kaolin product Sample C produced in Example 3 above was used as a pigment in a coating composition used for preparing an ULWC for rotogravure printing. The coating composition had the composition shown in Table 6 as follows.

TABLE 6

| Ingredient | Parts by weight |
|---|---|
| Pigment under test | 87 |
| Calcined kaolin | 5 |
| Titanium dioxide | 5 |
| Dispersant | 0.1 |
| Calcium stearate lubricant | 1 |
| Synthetic latex binder | 6 |

The calcined kaolin had a particle size distribution such that 90% by weight consisted of particles having an esd smaller than 2 μm.

The synthetic latex binder was a styrene butadiene rubber binder of the type which has been found to be suitable for use in rotogravure coating formulations. The parts by weight shown are parts by weight of latex solids.

The dispersant was a polyacrylate based dispersant.

The kaolin product C in accordance with an embodiment of the invention was compared with three commercially available products, namely commercially available pigments 1, 2 and 3, which were each separately made into the composition shown in Table 6 above.

Commercially available pigment 1 was a kaolin equivalent to Component A having a particle size distribution such that 90.4 by weight consisted of particles having an esd smaller than 2 μm, 75.5% by weight consisted of particles having an esd smaller than 1.0 μm and 23.3% consisted of particles having an esd smaller than 0.2 μm. The shape factor of the product was 60.2.

Commercially available pigment 2 was a kaolin clay having a psd such that 82.9% by weight consisted of particles having an esd smaller than 2 μm, 68.3% by weight consisted of particles having an esd smaller than 1 μm and 21.3% by weight consisted of particles having an esd smaller than 0.2 μm. The particle shape factor of the product was 44.6.

Commercially available pigment 3 was a kaolin equivalent to Component B having a psd such that 93.5% by weight consisted of particles having an esd smaller than 2 μm, 77.5% by weight consisted of particles having an esd smaller than 1 μm and 15.2% by weight consisted of particles having an esd smaller than 0.2 μm. The particle shape factor of the pigment was 14.7.

Each composition was coated onto a web of base paper of substance weight 31g.m⁻² by means of a pilot paper coating machine fitted with a short dwell time head. The paper speed was 1100 m.min⁻¹ and the blade angle was 45°. The solids concentration of the coating composition was adjusted so that the pressure of the hydraulic fluid supplied to a pressurisable tube used for biasing the blade against the web of paper was in the range of from 1.0 to 1.5 bas in order to provide the desired coat weight. The dry weight of the coating applied to the web of paper was in the range of from 5 g.m⁻² to 6.5 g.m⁻² calendering by passage ten times between the rolls of a pilot-scale supercalender at a temperature of 80° C. and a linear pressure of 230 kN.m⁻¹.

The samples of calendered coated paper were then tested for gloss, brightness, opacity, print gloss, and Parker Print Surf by the methods which were described in Example 4.

Samples of paper coated with the different coating compositions were also tested for gravure print quality by methods described in the article “Realistic paper tests for various printing processes” by A Swan, published in “Printing Technology”, Vol 13, No 1, Apr. 1969, pages 9-22. A gravure printing cylinder was used with an area of deeply etched cells to give a solid black area of less deeply etched cells to give a half-tone area. The half-tone area was used to estimate the percentage of gravure dots which were missing from the test print. This percentage was expressed as “% missing dots”. The solid black area was used to measure the gravure print density using a Macbeth density meter.

The results obtained are set forth in Tables 7 and 8 as follows.

TABLE 7
(At Equivalent Finishing Conditions)

| | | | Parker | | |
|---|---|---|---|---|---|
| | Gloss | | Print | Opacity | % |
| | (TAPPI | | Surf | (TAPPI | missing |
| Pigment | units) | Brightness | 100 kPa | units) | dots |
| Pigment | 51.9 | 71.2 | 1.06 | 84.8 | 1.4 |
| Product C | | | | | |
| Commercially | 50.8 | 71.0 | 1.08 | 83.6 | 1.4 |
| available | | | | | |
| Pigment 1 | | | | | |
| Commercially | 44.0 | 71.3 | 1.21 | 83.1 | 2.8 |
| available | | | | | |
| Pigment 2 | | | | | |
| Commercially | 53.3 | 72.1 | 1.09 | 83.8 | 2.0 |
| available | | | | | |
| Pigment 3 | | | | | |

TABLE 8
(At Equivalent Sheet Gloss)

| | | | Parker | | |
|---|---|---|---|---|---|
| | Gloss | | Print | Opacity | % |
| | (TAPPI | | Surf | (TAPPI | missing |
| Pigment | units) | Brightness | 1000 kPa | units) | dots |
| Pigment | 51.9 | 71.2 | 1.06 | 84.8 | 1.4 |
| Product C | | | | | |
| Commercially | 50.8 | 71.0 | 1.08 | 83.6 | 1.4 |
| available | | | | | |
| Pigment 1 | | | | | |
| Commercially | 51.3 | 70.3 | 1.03 | 82.5 | 3.5 |
| available | | | | | |
| Pigment 2 | | | | | |
| Commercially | 53.3 | 72.1 | 1.09 | 83.8 | 2.0 |
| available | | | | | |
| pigment 3 | | | | | |

It can be seen from Tables 7 and 8 that the pigment in accordance with an embodiment of the invention provides an ULWC paper, suitable for use in rotogravure printing, which paper has improved properties compared with a coated paper prepared using commercially available pigment 2 (which has a similar shape factor). The invention pigment also provides a better gravure print quality compared to commercially available pigments 2 and 3.

### EXAMPLE 6

Further paper coating compositions were prepared according to the formulations given in Example 4 earlier.

In these compositions, the pigments under test were, respectively:

The kaolin product C in accordance with an embodiment of the invention. The product C had a shape factor of 40.4.

Commercially available pigment 1—a kaolin equivalent to Component A having a particle size distribution such that 90.4% by weight consisted of particles having an esd smaller than 2 μm, 75.5% by weight consisted of particles having an esd smaller than 1.0 μm and 23.3% consisted of particles having an esd smaller than 0.2 μm. The shape factor of the product was 60.2.

Commercially available pigment 2—a kaolin clay having a psd such that 82.9% by weight consisted of particles having an esd smaller than 2 μm, 68.3% by weight consisted of particles having an esd smaller than 1 μm and 21.3% by weight consisted of particles having an esd smaller than 0.2 μm. The particle shape factor of the product was 44.6.

Each composition under test was coated onto base paper of substance weight 30 g.m⁻² by means of a coating machine of the type described in GB-A-1032536 fitted with a short dwell time head. The paper speed was 1100 m.min⁻¹. Samples of a coated paper were prepared at different coat weights in the range of from about 4 g.m⁻² to about 7 g.m⁻². The coated paper was dried and then subjected to calendering (finishing) by passage ten times between the rolls of a supercalender at a temperature of 100° C. and a pressure of 7 MPa.

The samples of calendered coated paper prepared from each of the three coating compositions were then tested for gloss, brightness, opacity, print gloss, and Parker Print Surf. In each case the measured values were plotted graphically against coat weight, and the value which corresponded to a coat weight of 4.5 g.m⁻² was found by interpolation.

The results are set forth in Tables 9 and 10 as follows.

TABLE 9
(At Equivalent Finishing Conditions)

| | | | Parker Print | | |
|---|---|---|---|---|---|
| Pigment | Gloss | Brightness | Surf | Opacity | Whiteness |
| Pigment | 56.88 | 72.43 | 1.29 | 91.96 | 56.03 |
| Product C | | | | | |
| Commercially | 56.76 | 72.21 | 1.32 | 91.73 | 55.15 |
| available | | | | | |
| pigment 1 | | | | | |
| Commercially | 46.58 | 72.13 | 1.46 | 91.08 | 54.63 |
| available | | | | | |
| pigment 2 | | | | | |

TABLE 10
(At Equivalent Gloss)

| | | | Parker Print | | |
|---|---|---|---|---|---|
| Pigment | Gloss | Brightness | Surf | Opacity | Whiteness |
| Pigment | 51.5 | 72.79 | 1.33 | 91.96 | 56.38 |
| Product C | | | | | |
| Commercially | 54.38 | 72.52 | 1.36 | 91.94 | 55.69 |
| available | | | | | |
| pigment 1 | | | | | |
| Commercially | 52.52 | 72.08 | 1.26 | 91.37 | 54.90 |
| available | | | | | |
| pigment 2 | | | | | |

It can be seen from Table 9 that the pigment in accordance with an embodiment of the invention provides an ULWC paper, suitable for use in offset printing, which paper has improved gloss, brightness, opacity and parker print surf as compared with coated papers which have been prepared using commercially available pigments which are generally recommended for preparing coated papers of this type.

### EXAMPLE 7

Further paper coating compositions were prepared according to the formulations given in Example 5 earlier.

In these compositions, the pigments under test were, respectively:

The kaolin product C in accordance with an embodiment of the invention. The product C had a shape factor of 40.4.

Commercially available pigment 1—a kaolin equivalent to Component A having a particle size distribution such that 90.4% by weight consisted of particles having an esd smaller than 2 μm, 75.5% by weight consisted of particles having an esd smaller than 1.0 μm and 23.3% consisted of particles having an esd smaller than 0.2 μm. The shape factor of the product was 60.2.

Commercially available pigment 2—a kaolin clay having a psd such that 82.9% by weight consisted of particles having an esd smaller than 2 μm, 68.3% by weight consisted of particles having an esd smaller than 1 μm and 21.3% by weight consisted of particles having an esd smaller than 0.2 μm. The particle shape factor of the product was 44.6.

Each composition was coated onto a web of base paper of substance weight 31 g.m⁻² by means of a pilot paper coating machine fitted with a short dwell time head. The paper speed was 1100 m.min⁻¹ and the blade angle was 44°. The solids concentration of each coating composition was adjusted so that the pressure of the hydraulic fluid supplied to a pressurizable tube used for biasing the blade against the web of paper was in the range of from 1.0 to 1.5 bars in order to provide the desired coat weight. The dry weight of the coating applied to the web of paper was in each case 6 g.m⁻². The coated paper was dried and then subjected to calendering by passage ten times between the rolls of a pilot-scale supercalender at a temperature of 80° C. and a linear pressure of 230 kN.m⁻¹.

The samples of calendered coated paper were then tested for gloss, brightness, opacity and Parker Print Surf.

The results obtained are set forth in Table 11 as follows.

TABLE 11
(At equivalent Sheet Gloss)

| | | | Parker Print | |
|---|---|---|---|---|
| Pigment | Gloss | Brightness | Surf | Opacity |
| Pigment | 53.32 | 72.54 | 1.58 | 92.48 |
| Product C | | | | |
| Commercially | 52.58 | 71.74 | 1.61 | 91.82 |
| available | | | | |
| pigment 1 | | | | |
| Commercially | 51.88 | 71.61 | 1.86 | 91.29 |
| available | | | | |
| pigment 2 | | | | |

### EXAMPLE 8

The kaolin product samples D and E were prepared in accordance with Example 3. Samples D and E had a psd such that 90.4% by weight consisted of particles having an esd smaller than 2 μm, 76.1% by weight consisted of particles having an esd smaller than 1 μm and 20.7% by weight consisted of particles having an esd smaller than 0.2 μm. The particle shape factor of the product was 48.

The kaolins were used as a pigment in a coating composition as described in Example 4. The coated paper was tested for gloss, brightness and opacity as described in Example 4 above. The coating had the composition given below in Table 12.

TABLE 12

| Ingredient | Parts by weight |
|---|---|
| Pigment under test | 83 |
| Hollow Core Plastic Pigment | 2 |
| Titanium dioxide | 10 |
| Dispersant | 0.1 |
| Lubricant | 1 |
| Synthetic latex binder | 10 |
| Calcined Kaolin | 5 |
| Starch | 7 |

Commercially available pigment 4—a kaolin having a psd such that 91.0% by weight consisted of particles having an esd smaller than 2 μm, 76% by weight consisted of particles having an esd smaller than 1 μm and 22% by weight consisted of particles having an esd smaller than 0.2 μm. The particle shape factor of the product was 29.0.

TABLE 13

| | | | Commercially |
|---|---|---|---|
| Ingredient | | | available |
| Clay | D | E | Pigment 4 |
| Titanium Dioxide | 10 | 8 | 10 |
| Plastic Pigment | 2 | 1.3 | 2 |
| Sheet Brightness | 71.4 | 70.3 | 70.2 |
| Opacity (Tappi | 83.0 | 82.0 | 81.4 |
| Units) | | | |
| Delta Gloss | 42 | 41 | 42 |

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A pigment product comprising a kaolin having a particle size distribution such that at least about 80% by weight of the particles have an equivalent spherical diameter less than about 2 μm and from about 15% to about 40% by weight of the particles have an equivalent spherical diameter less than about 0.25 μm and the particles have a shape factor in the range of from about 35 to about 60 and wherein the pigment product comprises a blend of
Component A: a particulate kaolin in which the particles have a shape factor of at least about 45, and
Component B: a particulate kaolin in which the particles have a shape factor of less than about 20.

2. The pigment product according to claim 1, wherein from about 85% to about 95% by weight of the particles have an equivalent spherical diameter less than about 2 μm.

3. The pigment product according to claim 1, wherein from about 90% to about 93% by weight of the particles have an equivalent spherical diameter less than about 2 μm.

4. The pigment product according to claim 1, wherein from about 20% to about 30% by weight of the particles have an equivalent spherical diameter less than about 0.25 μm.

5. The pigment product according to claim 1, wherein from about 25% to about 30% by weight of the particles have an equivalent spherical diameter less than about 0.25 μm.

6. The pigment product according to claim 1, wherein the shape factor of the particles is in the range of from about 35 to about 50.

7. The pigment product according to claim 6, wherein the shape factor of the particles is in the range of from about 35 to about 45.

8. The pigment product according to claim 7, wherein the shape factor of the particles is in the range of from about 40 to about 45.

9. A method of making a pigment product a kaolin having a particle size distribution such that at least about 80% by weight of the particles have an equivalent spherical diameter less than about 2 μm and from about 15% to about 40% by weight of the particles have an equivalent spherical diameter less than about 0.25 μm and the particles have a shape factor in the range of from about 35 to about 60, the method comprising
blending Component A: a particulate kaolin in which the particles have a shape factor of at least about 45; with
Component B: a particulate kaolin in which the particles have a shape factor of less than about 20.

10. A method according to claim 9, wherein the blend ratio of the Component A to the Component B is from about 1:1 to about 100: 1, by weight.

11. A method according to claim 10, wherein the blend ratio of Component A to Component B is from about 2:1 to about 50:1, by weight.

12. A method according to claim 11, wherein the blend ratio of Component A to Component B is from about 2:1 to about 10:1, by weight.

13. A method according to claim 9, wherein Component A is prepared by treating a sedimentary kaolin.

14. A method according to claim 9, wherein Component A is prepared by
(a) mixing a raw or partially processed kaolin clay with water to form an aqueous suspension;
(b) attrition grinding the suspension produced by step (a) such that the average shape factor of the kaolin clay is increased by at least about 10;
(c) separating the suspension of ground kaolin clay from the particulate grinding medium, and
(d) dewatering the suspension of ground kaolin clay separated in step (c).

15. A method according to claim 14, wherein in step (b), the average shape factor is increased by at least about 20.

16. A method according to claim 9, wherein Component B is prepared by the steps of
(a) dispersing a kaolin clay in an aqueous suspension of a water soluble dispersing agent to form an aqueous clay suspension;
(b) delaminating the kaolin clay in the aqueous clay suspension;
(c) separating the kaolin clay suspension into a coarse fraction and a fine fraction, admixing a portion of the fine fraction with the coarse fraction;
(d) surface treating the kaolin clay particles by admixing into the aqueous clay suspension a member from the group consisting of a water soluble amine, aluminum sulfate, and mixtures thereof; and
(e) obtaining the kaolin clay from the aqueous clay suspension.

17. The method according to claim 16, wherein the kaolin clay suspension is treated with a water soluble bleaching agent after surface treatment.

18. A coating composition for use in producing gloss coatings on paper and other substrates, which composition comprises an aqueous suspension of a particulate pigment and a hydrophilic adhesive, wherein the particulate pigment comprises the pigment product of claim 1.

19. A composition according to claim 18, wherein the adhesive forms from about 4% to about 30% of the solids of the composition on a dry weight basis.

20. A composition according to claim 18, wherein the solids content of the composition is from about 60% to about 90% by weight of the composition.

21. A composition according to claim 18, wherein at least about 80% by weight of the particulate pigment of the composition comprises the pigment product according to claim 1.

22. A composition according to claim 18, wherein the adhesive comprises a modified or unmodified starch.

23. A composition according to claim 18, wherein the adhesive comprises a binder other than starch.

24. A method of use of the coating composition according to claim 18 which comprises coating a sheet of paper with said composition and calendering the paper to form a gloss coating thereon.
